(19) United States
(12) Patent Application Publication
(10) Pub. No.: US 2015/0170510 A1
(43) Pub. Date: Jun. 18, 2015

(54) CONTROL METHOD, INFORMATION PROCESSOR, AND COMPUTER PROGRAM PRODUCT

(71) Applicant: Kabushiki Kaisha Toshiba, Tokyo (JP)

(72) Inventors: Yasukazu Higuchi, Kawasaki-shi (JP); Yoshihiro Ohmori, Ome-shi (JP)

(21) Appl. No.: 14/453,566

(22) Filed: Aug. 6, 2014

(30) Foreign Application Priority Data
Dec. 17, 2013 (JP) 2013-260507

(51) Int. Cl. G08C 17/02

(52) U.S. Cl. CPC G08C 17/02

(57) ABSTRACT

According to one embodiment, a control method is for controlling a first device of a first user by a hardware processor. The method includes: acquiring first user information regarding an attribute of the first user; selecting a second user fulfilling a first condition regarding a quality of a sleep from a user group, the user group comprising users determined by using the first user information, attributes of users in the user group being similar with an attribute of the first user; generating a control command comprising a first parameter in accordance with a second parameter used to control a second device of the second user; and transmitting the control command to the first device.

### CROSS-REFERENCE TO RELATED APPLICATIONS

This application is based upon and claims the benefit of priority from Japanese Patent Application No. 2013-260507, filed Dec. 17, 2013, the entire contents of which are incorporated herein by reference.

### FIELD

Embodiments described herein relate generally to a control method, an information processor, and a computer program product.

### BACKGROUND

There has been disclosed a technique comprising: monitoring, with a wearable terminal, user information of a user wearing the wearable terminal; controlling an external device such as an air conditioner and lighting (one example of a device) based on the monitored user information; and adjusting the surrounding environment of the user (temperature and illuminance, for example). Here, the user information includes a sleep state, biological information, a surrounding environment, and/or the like.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a configuration of a home appliance control system according to an embodiment;

FIG. 2 is an exemplary block diagram of a hardware configuration of a wearable terminal of the home appliance control system in the embodiment;

FIG. 3 is an exemplary block diagram of a functional configuration of each device of the home appliance control system in the embodiment;

FIG. 4 is an exemplary diagram of a configuration of data stored in a sensing information storage of a server in the embodiment; and

FIG. 5 is an exemplary sequence diagram of a processing of controlling a home appliance in the home appliance control system in the embodiment.

### DETAILED DESCRIPTION

In general, according to one embodiment, a control method is for controlling a first device of a first user by a hardware processor. The control method comprises: acquiring first user information regarding an attribute of the first user; selecting a second user fulfilling a first condition regarding a quality of a sleep from a user group, the user group comprising users determined by using the first user information, attributes of users in the user group being similar with an attribute of the first user; generating a control command comprising a first parameter in accordance with a second parameter used to control a second device of the second user; and transmitting the control command to the first device.

In the following, a control method, an information processor, and a control program according to an embodiment will be described with reference to the enclosed drawings.

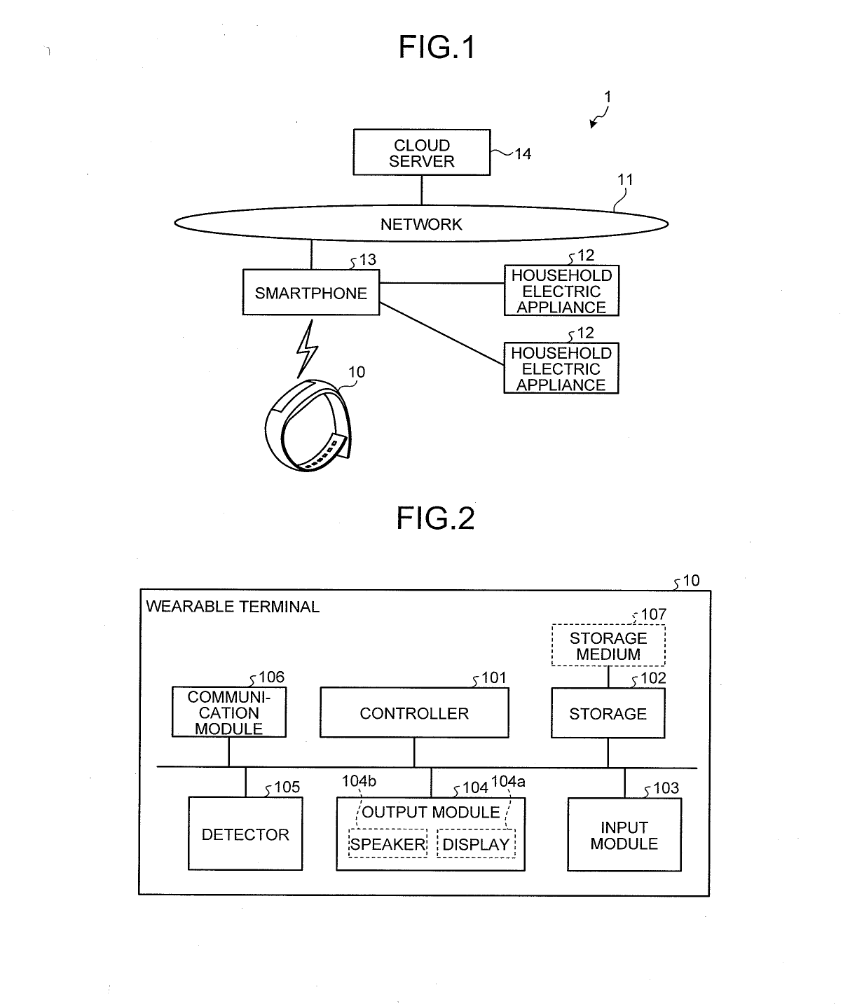

FIG. 1 is a diagram of a configuration of a home appliance control system according to an embodiment. As illustrated in FIG. 1, a home appliance control system 1 of the embodiment comprises a wearable terminal 10 (one example of a terminal), a home appliance 12 (lighting, an electric curtain that is opened and closed automatically, a television, an audio device, and an air conditioner, for example), a smartphone 13 (one example of an information processor), and a server 14. The wearable terminal 10 is wearable at a portion of a body of a user (one example of a first user), and can detect biological information of the user (an activity amount such as the number of steps and calorie consumption, a body temperature, sweating, a pulse, and a sleep state, for example). The home appliance 12 is one example of a first device (or a second device) used by a user (one example of the first user or a second user), and can control at least a portion of an environment surrounding the user (hereinafter, referred to as a surrounding environment). The smartphone 13 acquires user information of a user using the home appliance 12, uploads the user information onto the server 14 described later, and transmits to the home appliance 12 a control command generated based on a home appliance control parameter that is one example of a parameter acquired from the server 14 and used for the control of the home appliance 12. The server 14 is connected to the smartphone 13 through a network 11 such as the Internet, and generates a home appliance control parameter using biological information, etc., uploaded by the smartphone 13 and transmits the home appliance control parameter to the smartphone 13.

Here, the user information is information of a user, and contains at least biological information of the user. In the embodiment, the user information contains physical information of a user wearing the wearable terminal 10 (sex, an age, a height, a weight, a body fat percentage, and an average temperature, for example), biological information detected by the wearable terminal 10, a sleep schedule of a user wearing the wearable terminal 10 (wake-up scheduled time of a user and sleep time of a user, for example), activity information of a user wearing the wearable terminal 10 (walking, running, on a vehicle, sleeping, working, eating, and numerical information such as the number of steps and a movement distance, for example), and environmental information regarding the surrounding environment of a user wearing the wearable terminal 10 (an air temperature, moisture, noise, an air pressure, illuminance, and position information (latitude and longitude), for example). In the following description, the physical information, the biological information, the sleep schedule, the activity information, and the environmental information are described as user information when it is unnecessary to distinguish them from one another.

FIG. 2 is a block diagram of a hardware configuration of a wearable terminal of the home appliance control system in the embodiment. In the embodiment, the wearable terminal 10 comprises a controller 101, a storage 102, an input module 103, an output module 104, a detector 105, and a communication module 106, as illustrated in FIG. 2. A storage medium 107 such as a memory card that can transmit and receive various kinds of information to and from the storage 102 can be removably attached to the wearable terminal 10, as illustrated in FIG. 2.

The controller 101 is constituted by a central processing unit (CPU), etc., and controls modules of the wearable terminal 10. The storage 102 is constituted by a read only memory (ROM) and a random access memory (RAM), etc., and can store various kinds of information such as programs executed by the controller 101 and data used by the controller 101 when executing the programs.

The input module 103 is constituted by input keys, switches, etc., and can input user operation to the wearable terminal 10. The output module 104 is constituted by a liquid crystal display (LCD), etc., and comprises a display 104a that can display various kinds of information, a speaker 104b that outputs audio, a vibrator (not illustrated), etc. The wearable terminal 10 notifies a user of various kinds of information such as a state of the terminal and results of various kinds of processing performed in the terminal by display on the display 104a, audio output to the speaker 104b, or vibration of the vibrator (not illustrated).

The detector 105 detects the biological information (an activity amount, a body temperature, sweating, and a pulse, for example) of a user wearing the wearable terminal 10. The communication module 106 can perform communication with the smartphone 13 by wireless communication. In the embodiment, the communication module 106 transmits various kinds of information such as biological information detected by the detector 105 to the smartphone 13 and receives various kinds of information transmitted from the smartphone 13.

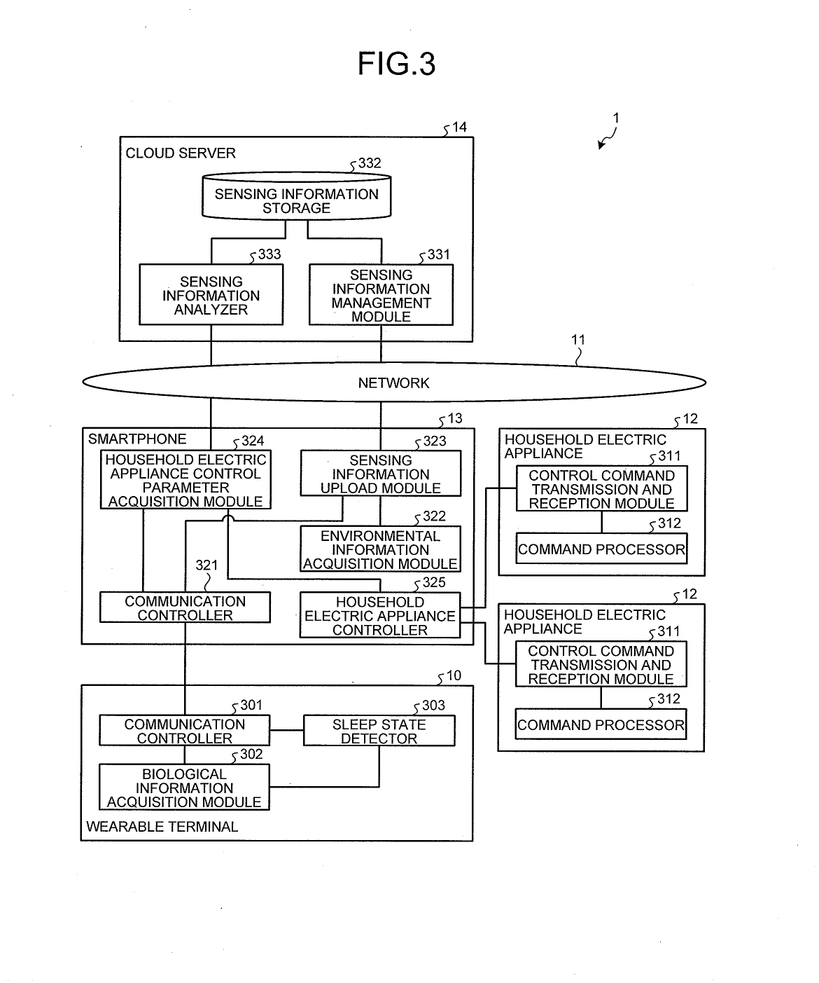

FIG. 3 is a block diagram of a functional configuration of each device of the home appliance control system in the embodiment. In the embodiment, the wearable terminal 10 comprises a communication controller 301, a biological information acquisition module 302, and a sleep state detector 303, as illustrated in FIG. 3. The biological information acquisition module 302 acquires biological information detected by the detector 105. The biological information acquisition module 302 detects user activity information based on the acquired biological information (an activity amount, for example). The sleep state detector 303 detects a sleep state (a length of sleep time, a length of awakening time, an awakening frequency, deep sleep (non-rapid eye movement (REM) sleep), and shallow sleep (REM sleep), for example) of a user wearing the wearable terminal 10 based on the biological information acquired by the biological information acquisition module 302.

The communication controller 301 controls the communication module 106 to transmit the physical information of the user input from the input module 103, the sleep schedule input from the input module 103 (or the smartphone 13), the biological information (containing the sleep state detected by the sleep state detector 303) and the activity information acquired by the biological information acquisition module 302, etc., to the smartphone 13. In the embodiment, the communication controller 301 transmits the biological information and the activity information acquired by the biological information acquisition module 302 and the sleep state detected by the sleep state detector 303 to the smartphone 13 at every predetermined time (at every several minutes, for example).

The home appliance 12 comprises a control command transmission and reception module 311 that receives a control command from the smartphone 13 and a command processor 312 that controls the home appliance 12 in accordance with the control command received from the smartphone 13, as illustrated in FIG. 3.

As illustrated in FIG. 3, the smartphone 13 (one example of an information processor) comprises a communication controller 321, an environmental information acquisition module 322, a sensing information upload module 323, a home appliance control parameter acquisition module 324, and a home appliance controller 325. The communication controller 321 controls a communication module (not illustrated) to receive (acquire) physical information, biological information, activity information, etc., transmitted from the wearable terminal 10. The environmental information acquisition module 322 acquires environmental information regarding a surrounding environment of a user wearing the wearable terminal 10. The sensing information upload module 323 adds a user identifier (ID) allowing identification of a user wearing the wearable terminal 10 to user information that is sensing information, such as physical information, a sleep schedule, biological information, and activity information, received by the communication controller 321 and environmental information acquired by the environmental information acquisition module 322, and uploads (transmits) the sensing information onto the server 14. The home appliance control parameter acquisition module 324 acquires (receives) a home appliance control parameter generated by the server 14. The home appliance controller 325 transmits a control order generated based on the home appliance control parameter acquired by the home appliance control parameter acquisition module 324 to the home appliance 12. The user information acquired by the communication controller 321 and the environmental information acquisition module 322 contains time at which the user information is acquired (hereinafter, referred to as acquisition time).

In the embodiment, the environmental information acquisition module 322 acquires environmental information, at every predetermined time (at every several minutes, for example). Then, the sensing information upload module 323 transmits, every time the communication controller 321 receives biological information and activity information, the received biological information and activity information to the server 14 as sensing information. The sensing information upload module 323 transmits, every time the environmental information acquisition module 322 acquires environmental information, the acquired environmental information to the server 14 as sensing information.

In the embodiment, the environmental information acquisition module 322 of the smartphone 13 acquires environmental information. However, embodiments are not limited thereto, and the wearable terminal 10 may acquire environmental information, or an external device other than the wearable terminal 10 and the smartphone 13 may acquire environmental information.

As illustrated in FIG. 3, the server 14 comprises a sensing information management module 331, a sensing information storage 332, and a sensing information analyzer 333. The sensing information management module 331 receives sensing information transmitted from the smartphone 13 and stores, for each user, the received sensing information in the sensing information storage 332. The sensing information storage 332 stores, for each user, the sensing information received by the sensing information management module 331. The sensing information analyzer 333 generates a home appliance control parameter used for the control of the home appliance 12 that can control at least a portion of a surrounding environment of a user identified by a user ID added to the sensing information received by the sensing information management module 331, and transmits the home appliance control parameter to the smartphone 13.

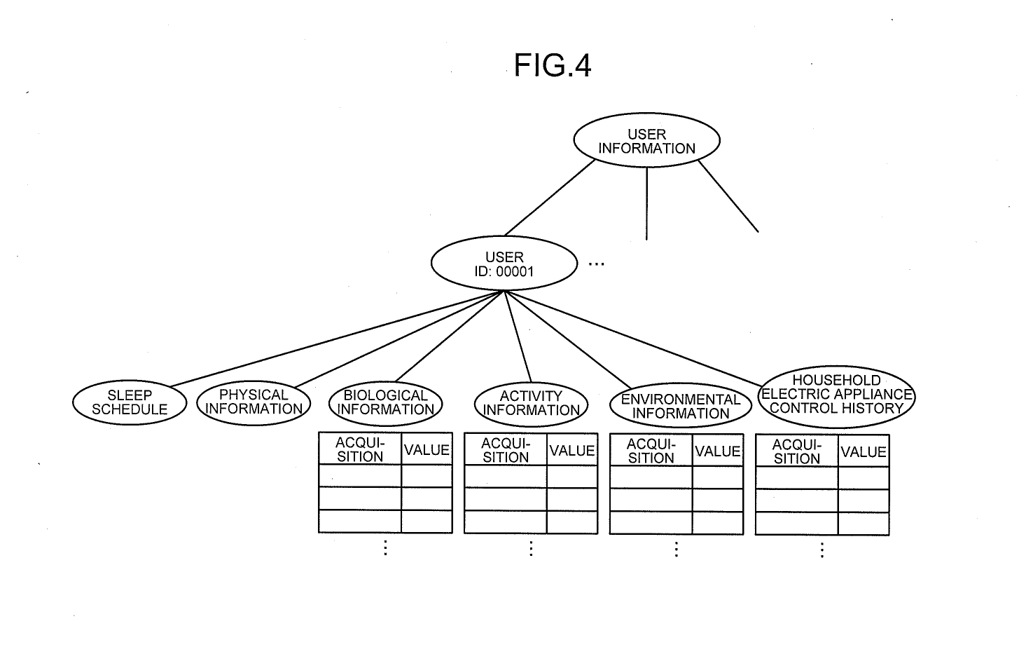

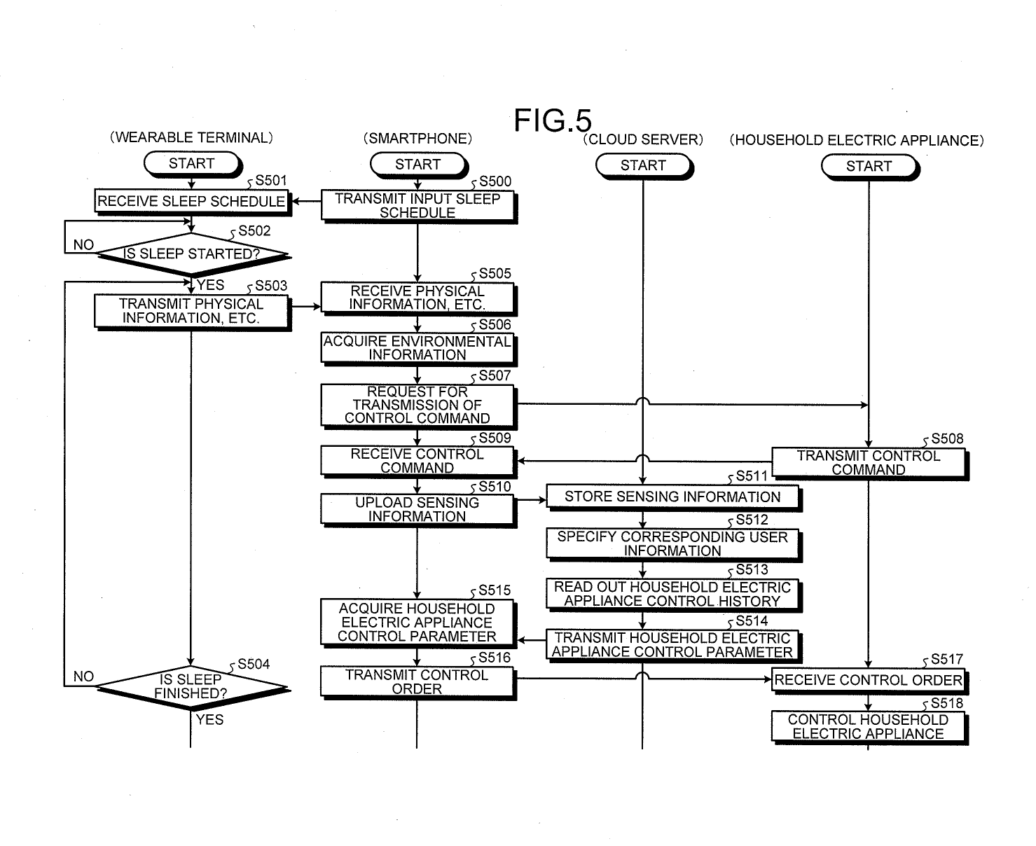

Here, the configuration of data stored in the sensing information storage 332 will be described with reference to FIG. 4. FIG. 4 is a diagram of a configuration of data stored in a sensing information storage of a server in the embodiment. The sensing information storage 332 stores user information such as a sleep schedule, physical information, biological information, activity information, and environmental information received as sensing information and a history of home appliance control parameters generated by the sensing information analyzer 333 using the user information (hereinafter, referred to as a home appliance control parameter history), in association with a user ID added to the sensing information received by the sensing information management module 331 (user ID: “00001”, for example), as illustrated in FIG. 4. In the embodiment, each of the pieces of the biological information, the activity information, and the environmental information stored in the sensing information storage 332 contains acquisition time at which the information is acquired by the smartphone 13 (the communication controller 321 and the environmental information acquisition module 322) and values indicating the information. The home appliance control history stored in the sensing information storage 332 contains time at which home appliance control parameters as the home appliance control history are generated (hereinafter, referred to as setting time) and values indicating the home appliance control parameters.

The following will describe the detail of processing of controlling the home appliance 12 in the home appliance control system 1 of the embodiment with reference to FIG. 5. FIG. 5 is a sequence diagram of a processing of controlling a home appliance in the home appliance control system in the embodiment.

When a sleep schedule is input to the smartphone 13 and the input sleep schedule is transmitted to the wearable terminal 10 (S500), the controller 101 of the wearable terminal 10 receives the sleep schedule from the smartphone 13 and sets the received sleep schedule (S501) before the communication controller 301 transmits physical information, biological information, activity information, etc. When the controller 101 sets the sleep schedule, the communication controller 301 determines whether a user wearing the wearable terminal 10 is starting to sleep based on the sleep state detected by the sleep state detector 303 or the setting of the sleep schedule in accordance with user operation input from the input module 103 (S502). Then, when the communication controller 301 determines that the user wearing the wearable terminal 10 is starting to sleep (Yes at S502), it transmits the set sleep schedule, the physical information input from the input module 103, and the biological information (containing a sleep state detected by the sleep state detector 303) and the activity information acquired by the biological information acquisition module 302 to the smartphone 13 (S503). The communication controller 301 determines whether the sleep is finished based on the sleep state detected by the sleep state detector 303 (S504). Then, when the communication controller 301 determines that the sleep is finished (Yes at S504), it finishes transmission of physical information, etc. By contrast, when the communication controller 301 determines that the sleep is not finished (No at S504), the processing returns to S503, and the communication controller 301 continues transmission of physical information, etc.

The communication controller 321 of the smartphone 13 receives (acquires) physical information, biological information, activity information, a sleep schedule, etc., transmitted from the wearable terminal 10 (S505). Moreover, the environmental information acquisition module 322 acquires environmental information regarding the surrounding environment of the user wearing the wearable terminal 10 at every predetermined time (S506). In the embodiment, the communication controller 321 and the environmental information acquisition module 322 function as acquisition modules that acquire user information of the first user. In other words, the communication controller 321 and the environmental information acquisition module 322 function as input modules configured to receive user information of the first user. Furthermore, in the embodiment, the home appliance controller 325 requests the home appliance 12 to transmit a control command currently used for the control of each module of the home appliance 12 (S507). The control command transmission and reception module 311 of the home appliance 12 transmits, in response to the transmission request from the smartphone 13, a control command currently used for the control of each module (in other words, the latest control order received from the smartphone 13) to the smartphone 13 (S508). Then, the home appliance controller 325 of the smartphone 13 receives the control command transmitted from the home appliance 12 (S509). Next, the sensing information upload module 323 adds a user ID to sensing information that includes user information such as physical information, biological information, activity information, and a sleep schedule received by the communication controller 321; environmental information acquired by the environmental information acquisition module 322; and a home appliance control parameter corresponding to the received control order (a home appliance control history), and uploads the sensing information onto the server 14 (S510).

The sensing information management module 331 of the server 14 receives the sensing information transmitted from the smartphone 13 and stores, in the sensing information storage 332, the received sensing information in association with a user ID added to the sensing information (S511). When the sensing information is received from the smartphone 13, the sensing information analyzer 333 specifies, from among pieces of user information stored in the sensing information storage 332 in association with user IDs other than the user ID added to the received sensing information, at least one of the pieces of the user information which corresponds to (similar to, for example) user information contained in the received sensing information (hereinafter, referred to as corresponding user information). Here, the user information is, for example, physical information, biological information, activity information, environmental information, and/or the like (S512).

In the embodiment, the sensing information analyzer 333 specifies, using collaborative filtering, etc., at least one piece of corresponding user information in the sensing information storage 332 that corresponds to user information contained in the received sensing information (in other words, that are similar to user information contained in the received sensing information). For example, the sensing information analyzer 333 specifies, as corresponding user information, user information in the sensing information storage 332 that matches (or that can be considered to match) at least partially user information contained in the received sensing information. Alternatively, the sensing information analyzer 333 specifies, as corresponding user information, user information that matches in information high in predetermined priority (biological information, for example) among user information contained in the received sensing information (physical information, biological information, activity information, environmental information, etc.).

Furthermore, the sensing information analyzer 333 reads out a home appliance control history (a home appliance control parameter used for the control of the home appliance 12 of the second user) stored in association with corresponding user information of a user (one example of the second user) satisfying a predetermined sleep condition that is a condition regarding sleep (one example of a first condition) among the specified corresponding user information (S513). Here, the predetermined sleep condition is defined by information related to at least one of a length of sleep and a depth of sleep of the user. The sensing information analyzer 333 reads out a home appliance control history stored in association with corresponding user information that contains biological information (a length of sleep, deep sleep, etc., as a sleep state) satisfying a predetermined sleep condition among the specified corresponding user information. The sensing information analyzer 333 may read out a home appliance control history stored in association with corresponding user information that contains a sleep state indicating that the quality of sleep is improved among the specified corresponding user information.

Then, the sensing information analyzer 333 generates, based on the read home appliance control history, a home appliance control parameter used for the control of the home appliance 12 that can control the surrounding environment of a user specified by a user ID added to the received sensing information, and transmits the home appliance control parameter to the smartphone 13 (S514). Moreover, the sensing information analyzer 333 may perform clustering based on sensing information of users having a favorable sleep state (users having a long sleep time and users having deep sleep, for example) among users whose sensing information is stored in the sensing information storage 332, calculate a home appliance control parameter representing the cluster based on a home appliance control history contained in sensing information in each cluster, and transmit, when generating a home appliance control parameter of a user who is sleeping currently, a home appliance control parameter of a cluster near the user to the smartphone 13.

In the embodiment, when there exist a plurality of users satisfying a predetermined sleep condition among the corresponding user information specified from the sensing information storage 332, the sensing information analyzer 333 generates, as a home appliance control parameter, information by averaging a plurality of home appliance control histories stored in association with the corresponding user information satisfying the predetermined sleep condition. Moreover, the sensing information analyzer 333 generates a home appliance control parameter based on home appliance control histories except deviation information among the home appliance control histories. Here, the deviation information is a home appliance control history that significantly deviates from other home appliance control histories in the statistics of the read home appliance control histories. The sensing information analyzer 333 stores, in the sensing information storage 332, the generated home appliance control parameter in association with the received sensing information.

The home appliance control parameter acquisition module 324 of the smartphone 13 acquires the home appliance control parameter transmitted from the server 14 (S515). The home appliance controller 325 (one example of a transmission module) transmits a control command generated based on the home appliance control parameter acquired by the home appliance control parameter acquisition module 324 to the home appliance 12 (S516). That is, the home appliance controller 325 transmits, to the household electric appliance 12, the control command generated based on home appliance control histories of other user (one example of the second user) satisfying a predetermined sleep condition. Here, the other user is at least one user other than the user whose user information is acquired, and the other user has corresponding user information that corresponds to the acquired user information.

In this manner, even when the home appliance control history of an individual user, which is necessary to obtain his/her good sleep, is not sufficiently accumulated, it is possible to transmit a control command having a target value set based on home appliance control histories of other users to the home appliance 12 and thus achieve highly effective sleep support without complicated analysis. Moreover, even when the home appliance control history of an individual user, which is necessary to obtain his/her good sleep, is not sufficiently accumulated, it is possible to effectively increase the home appliance control history used for the generation of a control command and thus improve the effect of sleep support without correcting an algorithm generating the control order.

The control command transmission and reception module 311 of the home appliance 12 receives the control command transmitted from the smartphone 13 (S517). Then, the command processor 312 controls each module of the home appliance 12 in accordance with the control command received by the control command transmission and reception module 311 (S518).

In this manner, the home appliance control system 1 of the embodiment can achieve highly effective sleep support without complicated analysis even when the home appliance control history of an individual user, which is necessary to obtain his/her good sleep, is not sufficiently accumulated.

In the embodiment, the smartphone 13 is used as an information processor that transmits a home appliance control parameter to the home appliance 12. However, embodiments are not limited thereto, and there may be used a home gateway, a tablet terminal, a personal computer, a wearable terminal, etc., as an information processor that transmits a home appliance control parameter to the home appliance 12.

In the embodiment, the smartphone 13 acquires the home appliance control parameter generated by the server 14 and transmits the acquired home appliance control parameter to the home appliance 12. However, the wearable terminal 10 may acquire the home appliance control parameter generated by the server 14 and transmit a control order based on the acquired home appliance control parameter to the home appliance 12.

A computer program executed by the wearable terminal 10, the smartphone 13, and the server 14 according to the embodiment is written in a ROM to be provided, for example. The computer program executed by the server 14 according to the embodiment may be recorded in a computer-readable recording medium such as a compact disc read only memory (CD-ROM), a flexible disk (FD), a compact disc recordable (CD-R), and a digital versatile disc (DVD), to be provided as an installable or executable file.

The computer program executed by the wearable terminal 10, the smartphone 13, and the server 14 according to the embodiment may be stored in a computer connected to a network such as the Internet and provided by being downloaded via the network. Furthermore, the computer program executed by the wearable terminal 10, the smartphone 13, and the server 14 according to the embodiment may be provided or distributed via a network such as the Internet.

The computer program executed by the wearable terminal 10 according to the embodiment is of a module configuration comprising the above-described modules (the communication controller 301, the biological information acquisition module 302, and the sleep state detector 303). As an actual hardware, the CPU (processor) reads out the computer program from the above-described ROM and executes it, whereby the modules described above are loaded on a main storage, and the communication controller 301, the biological information acquisition module 302, and the sleep state detector 303 are generated on the main storage.

The computer program executed by the smartphone 13 according to the embodiment is of a module configuration comprising the above-described modules (the communication controller 321, the environmental information acquisition module 322, the sensing information upload module 323, the home appliance control parameter acquisition module 324, and the home appliance controller 325). As actual hardware, the CPU (processor) reads out the computer program from the above-described ROM and executes it, whereby the modules described above are loaded on a main storage, and the communication controller 321, the environmental information acquisition module 322, the sensing information upload module 323, the home appliance control parameter acquisition module 324, and the home appliance controller 325 are generated on the main storage.

The computer program executed by the server 14 according to the embodiment is of a module configuration comprising the above-described modules (the sensing information management module 331 and the sensing information analyzer 333). As actual hardware, the CPU (processor) reads out the computer program from the above-described ROM and executes it, whereby the modules described above are loaded on a main storage, and the sensing information management module 331 and the sensing information analyzer 333 are generated on the main storage.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control method for controlling a first device of a first user by a hardware processor, the control method comprising:
acquiring first user information regarding an attribute of the first user;
selecting a second user fulfilling a first condition regarding a quality of a sleep from a user group, the user group comprising users determined by using the first user information, attributes of users in the user group being similar with an attribute of the first user;
generating a control command comprising a first parameter in accordance with a second parameter used to control a second device of the second user; and
transmitting the control command to the first device.

2. The control method of claim 1, wherein the first device and the second device are capable of controlling at least a portion of a surrounding environment of a user.

3. The control method of claim 1, wherein the first user information is acquired from a terminal worn at a portion of a body of the first user.

4. The control method of claim 1, wherein the first sleep-related condition is defined in accordance with information related to at least one of a length of sleep and a depth of sleep of a user.

5. The control method of claim 1, wherein the first user information contains at least biological information of the first user.

6. An information processor comprising:
an input controller configured to receive first user information regarding an attribute of a first user of a first device; and
a transmission controller, wherein
the transmission controller is configured to select a second user fulfilling a first condition regarding a quality of a sleep from a user group, the user group comprising users determined by using the first user information, attributes of users in the user group being similar with an attribute of the first user,
the transmission controller is configured to generate a control command comprising a first parameter in accordance with a second parameter used to control a second device of the second user, and
the transmission controller is configured to transmit the control command to the first device.

7. The information processor of claim 6, wherein the first device and the second device are capable of controlling at least a portion of a surrounding environment of a user.

8. The information processor of claim 6, wherein the input controller is configured to receive the first user information from a terminal worn at a portion of a body of the first user.

9. The information processor of claim 6, wherein the first sleep-related condition is defined in accordance with information related to at least one of a length of sleep and a depth of sleep of a user.

10. The information processor of claim 6, wherein the input controller is configured to receive the first user information comprising at least biological information of the first user.

11. A computer program product having a non-transitory computer readable medium including programmed instructions for controlling a first device of a first user, wherein the instructions, when executed by a computer, cause the computer to perform:
acquiring first user information regarding an attribute of the first user;
selecting a second user fulfilling a first condition regarding a quality of a sleep from a user group, the user group comprising users determined by using the first user information, attributes of users in the user group being similar with an attribute of the first user;
generating a control command comprising a first parameter in accordance with a second parameter used to control a second device of the second user; and
transmitting the control command to the first device.

12. The computer program product of claim 11, wherein the first device and the second device are capable of controlling at least a portion of a surrounding environment of a user.

13. The computer program product of claim 11, wherein the first user information is acquired from a terminal worn at a portion of a body of the first user.

14. The computer program product of claim 11, wherein the first sleep-related condition is defined in accordance with information related to at least one of a length of sleep and a depth of sleep of a user.

15. The computer program product of claim 11, wherein the first user information contains at least biological information of the first user.
